(19) United States
(12) Patent Application Publication
(10) Pub. No.: US 2016/0247068 A1
(43) Pub. Date: Aug. 25, 2016

(54) SYSTEM AND METHOD FOR AUTOMATIC QUESTION ANSWERING

(71) Applicant: TENCENT TECHNOLOGY (SHENZHEN) COMPANY LIMITED, Shenzhen (CN)

(72) Inventor: FEN LIN, Shenzhen (CN)

(73) Assignee: TENCENT TECHNOLOGY (SHENZHEN) COMPANY LIMITED

(21) Appl. No.: 15/144,373

(22) Filed: May 2, 2016

Related U.S. Application Data
(63) Continuation of application No. PCT/CN2014/089717, filed on Oct. 28, 2014.

(30) Foreign Application Priority Data
Nov. 1, 2013 (CN) 2013-10535062.8

(51) Int. Cl. G06N 5/02; G10L 15/22; G06N 99/00; G06F 17/27

(52) U.S. Cl. CPC G06N 5/02; G06F 17/271; G10L 15/22; G06N 99/005

(57) ABSTRACT

A system and method for automatic question answering is provided. The system includes: a user inputting module configured to receive question information; a question analyzing module configured to analyze the question information, and determine a set of keywords, a question type and a user intention type corresponding to the question information; a syntax retrieving and ranking module configured to retrieve, in a question and answer library and a category tree, answer candidates based on the question information, the set of keywords, the question type and the user intention type, determine a retrieval relevance between each of the answer candidates and the question information and rank the answer candidates according to the retrieval relevance, each of the answer candidates having a sequence number; and an outputting module configured to output an answer candidate ranked with a specified sequence number. By using the application, lower costs for collection and improve successful rate of answers are realized by the system for automatic question answering.

### CROSS REFERENCE TO RELATED APPLICATIONS

This application is a continuation of PCT/CN2014/089717 filed on Oct. 28, 2014, which claims benefit of priority to Chinese Application No. 2013105350628, filed on Nov. 1, 2013. The content of the aforementioned patent applications is hereby incorporated by reference in its entirety.

### FIELD OF THE APPLICATION

The present application relates to a field of human-machine intelligence interaction technology, and particularly, to a system and method for automatic question answering.

### BACKGROUND

The system for automatic question answering takes a natural language understanding technology as a core. With the natural language understanding technology, a computer can understand a conversation with a user to implement an effective communication between human and the computer. A chatting robot system generally applied in current computer customer service systems may be a kind of automatic question answering system, which refers to an artificial intelligence system automatically conversing with a user using the natural language understanding technology.

### SUMMARY OF THE APPLICATION

The application provides a system and method for automatic question answering, in order to lower costs for collection and improve successful rate of results answered by the system for automatic question answering.

One aspect of the application provides a system for automatic question answering. The system comprises: a user inputting module configured to receive question information; a question analyzing module configured to analyze the question information, and determine a set of keywords, a question type and a user intention type corresponding to the question information; a syntax retrieving and ranking module configured to retrieve, in a question and answer library and a category tree, answer candidates based on the question information, the set of keywords, the question type and the user intention type, determine a retrieval relevance between each of the answer candidates and the question information, and rank the answer candidates according to the retrieval relevance, each of the answer candidates having a sequence number; and an outputting module configured to output one of the answer candidates ranked with a specified sequence number.

After receiving question information input by a user, technical solutions provided by the application determine not only keywords but also a question type and a user intention type; retrieve, in a question and answer library and a category tree, answer candidates matching the question according to the question information, the keywords, question type and user intention type; determine a retrieval relevance between each of the answer candidates and the question and rank the answer candidates based on the retrieval relevance; and output an answer candidate ranked with a specified sequence number (generally, an answer candidate ranking first). Accordingly, the technical solutions analyze the question type and the user intention type, and introduce the category tree matching method. Therefore, when there is no question and answer pair matching a question in the question and answer library, or a retrieval relevance between each of matched answers in the question and answer library and the question are low, the question may be matched by an answer in the category tree, so that successful rate of results answered by the system for automatic question answering is improved. As scale of nodes of the category tree is not too large (generally, smaller than 1 k), with limited costs, the question and answer library does not necessarily cover all questions possibly proposed by users and higher successful rate of answers may be reached. As a result, the application reduces costs for operation and collection of the question and answer library and saves storage resources occupied by the question and answer library.

### DESCRIPTION OF THE DRAWINGS

FIG. 1a is a schematic diagram of an embodiment of a system for automatic question answering described by the application;

FIG. 1b is a schematic diagram of another embodiment of the system for automatic question answering described by the application;

FIG. 2 is a schematic diagram of a question analyzing module described by the application;

FIG. 3 is a schematic diagram of a syntax retrieving and ranking module described by the application;

FIG. 4 shows a schematic diagram of a category tree corresponding to a chatting robot in a public role;

FIG. 5a is a flow diagram of an embodiment of a method for automatic question answering described by the application; and

FIG. 5b is a flow diagram of another embodiment of the method for automatic question answering described by the application.

### DETAILED DESCRIPTION

The application will be further illustrated in details in connection with accompanying drawings and particular embodiments.

Systems for automatic question answering are generally question answering conversation library based text conversation systems, which are often implemented by following steps. First, a user inputs texts; and then the systems find the most matched texts by keywords retrieving and rule matching and return the most matched texts to the user as an answer.

An automatic question answering system usually includes a user interacting module, a retrieving module and a question answering conversations library module. The user interacting module is configured to interact with a user and receive question information input by the user by an interaction interface, and return an answer to the question on the interaction interface.

The question answering conversations library is configured to set and store various question answering conversations pairs. For example, when the user inputs a text of “Hello” into the chatting robot system, the chatting robot returns an answer of “Hello, I am XX”, and thus “Hello” and “Hello, I am XX” compose a question answering conversation pair. Wherein, “Hello” input by the user is called question information and “Hello, I am XX” returned by the system is called an answering result.

The retrieving module is configured to retrieve the answering result matching the question information in the question answering conversations library, according to the keywords and rules.

Often, such an automatic question answering system (i.e., chatting robot system) usually require a massive question answering conversations library. That is to say, the massive question answering conversations pairs in the question answering conversations library must cover all questions may be proposed by users). As a result, operators of the chatting robot systems have to engage in a long term operation and collection in order to acquire a question answering conversations library fully covering cover all questions may be proposed by users. Therefore, the operators have to pay for high costs for operation and collection and a large number of question answering conversations occupy a lot of storage resources when stored in the question answering conversations library.

Moreover, if there is no question answering conversation pair matching the user's input, the chatting robot system cannot answer the question proposed by the user. Consequently, the question answering may fail. Alternatively, general means to save the situation is changing the topic of the conversation or randomly outputting an answer, which is of low matching degree to the question input by the user, (equivalently to failing to answer the question).

In various embodiments of the present disclosure, various automatic answering function modules may be integrated in one processing unit or separately exist, or two or more modules may be integrated in one unit. The integrated units may be implemented as hardware or software function units. In various embodiments of the present disclosure, various function modules may located in one terminal (e.g., a smart phone or a laptop), or network node (e.g., a computer), or be separated into several terminals or network nodes.

A terminal or a network node may be a smart phone, a computer, a tablet computer, or other devices with computing and user interaction capabilities. For example, the automatic question answering system may be implemented as an application on a smartphone. The user may input (by audio or text) a question using the application through the microphone or touch screen. The system may receive the question information. The system may analyze the question information and determine a set of keywords, a question type and a user intent type. The system may retrieve from a question and answer library and a category tree. The system may select answer candidates based on the question information, the set of keywords, the question type and the user intent type. In one embodiment, the analyzing step and the retrieving steps may be implemented by software programs on and one or more processors on the smartphone. That is, the corresponding software programs for implementing the analyzing and retrieving steps would be stored in the memory of the smartphone. In one embodiment, the analyzing step and the retrieving steps may be implemented by software programs on and one or more processors on another computer that can be accessed by the smartphone. In this case, the corresponding software programs for implementing the analyzing and retrieving steps would be stored in the memory of the computer that can be accessed by the smart phone.

The question and answer library may be stored in the memory of the smartphone or stored in the memory of another computer that can be accessed by the smartphone. Once the system retrieves an answer, it then outputs the answer, through a user interface, such as an audio output (through the speaker) or a textual output (on the display) of the smartphone. That is, the smartphone may provide the answer with an audio output (a vice reading the answer) or a visual output (a screen with the answer displayed).

The present disclosure also provides a method for automatic question answering, which may be performed by the system for automatic question answering.

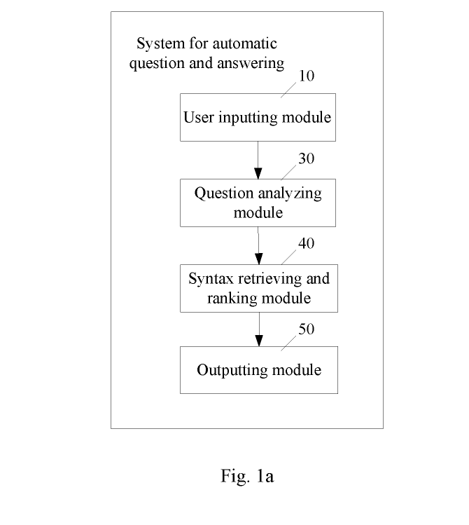

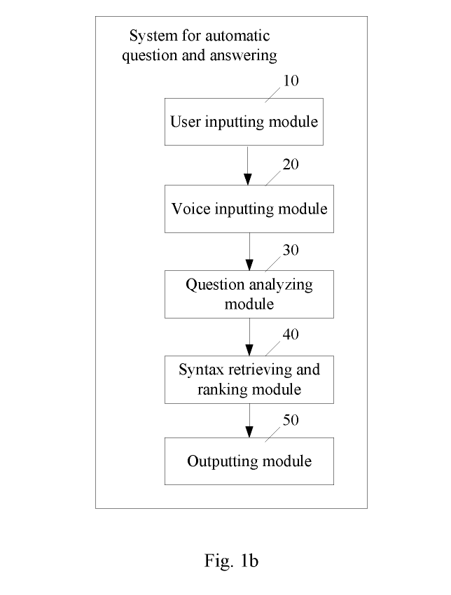

FIG. 1a is a schematic diagram of an embodiment of a system for automatic question answering described by the application. As shown in FIG. 1a, this embodiment may be applied to a scene where a user is required to input question information only by texts. The question answering system particularly includes following modules.

A user inputting module 10 is configured to receive question information input by a user. For example a user inputting module 10 may include a keyboard or a touch screen, and related software programs and hardware.

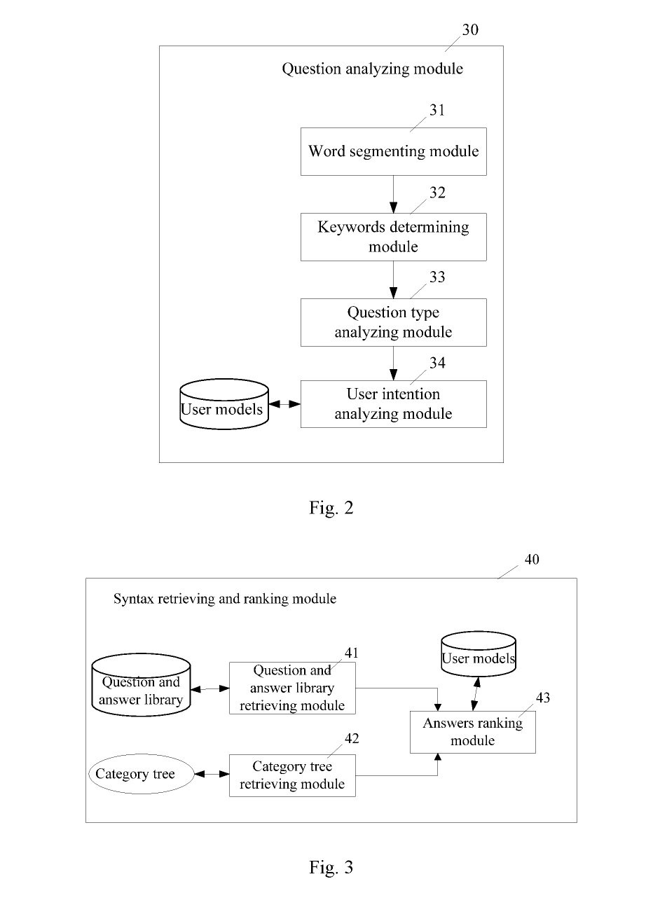

A question analyzing module 30 is configured to analyze the received question information, and determine a set of keywords, a question type and a user intention type corresponding to the question information. That is to say, the question analyzing module 30 transforms the question information input by the user into information into a machine-understandable form. FIG. 2 provides a schematic diagram of the question analyzing module 30 and detailed description of a question analyzing process will be made referring to FIG. 2. The question analyzing module 30 may include software programs, when executed by a processor, that may perform analyzing functions, such as analyzing the question inputted by the user.

A syntax retrieving and ranking module 40 is configured to retrieve, in a question and answer library and a category tree, answer candidates according to the question information, the set of keywords, question type and user intention type, determine a retrieval relevance between each of the answer candidates and the question information and rank the answer candidates according to the retrieval relevance, each of the answer candidates having a sequence number. FIG. 3 provides a schematic diagram of the syntax retrieving and ranking module 40 and detailed description of syntax retrieving and ranking process will be made referring to FIG. 3. An outputting module 50 is configured to output one of the answer candidates ranked with a specified sequence number, for example, an answer candidate ranked first or top n (wherein n is an integer). The outputting module 50 may include a speaker and its related software programs and hardware. The outputting module 50 may deliver the answer through the speaker.

In the embodiment as shown in FIG. 1a, the input question information may be text information; the user inputting module 10 may provide an interface (such as, a chat window with a touch screen) to the user for inputting the text information; and the questioning user may input the question information in text form by the chat window.

FIG. 1b is a schematic diagram of another embodiment of the system for automatic question answering described by the application. As shown in FIG. 1b, this embodiment may be applied to a scene where a user inputs question information by voice. This embodiment differs from the embodiment shown by FIG. 1a in that: the user inputting module 10 may provide a module (such as, a audio inputting module, a microphone) for voice input, which may be connected to an external microphone to receive voice information input by a user; and the system for automatic question answering of this embodiment further includes a voice recognizing module 20 between the user inputting module 10 and the question analyzing module 30, except the user inputting module 10, the question analyzing module 30, the syntax retrieving and ranking module 40 and the outputting module 50. When the user inputting module 10 receives voice information input by a user, it will send the voice information to the voice recognizing module 20. The voice recognizing module 20 is configured to recognize the voice information and transform the voice information into text expressions, i.e., corresponding text information, and then output the corresponding text information as a recognized result to the question analyzing module 30. Accordingly, question answering conversations between a user and the system for automatic question answering may be implemented in voice to bring a sense of reality and freshness to the user. While the user inputting module 10 receives text information input by a user, it will directly transmit the text information to the question analyzing module 30. Approaches for recognizing voice information into text information may refer to known voice recognition technology, and is thus not repeated herein.

The question analyzing module 30 and the syntax retrieving and ranking module 40 will be described in details below.

FIG. 2 is a schematic diagram of the question analyzing module 30 described by the application. The question analyzing module 30 particularly includes following modules.

A word segmenting module 31 is configured to process the question information by word segmentation and/or part-of-speech tagging, and obtain a processing result. Word segmentation and/or part-of-speech tagging is the first stage of natural language processing. Word segmentation is the problem of dividing a string of written language into its component words, including ambiguous word segmentation and unknown word recognition. Part-of-speech tagging is the process of marking up a word in a text as corresponding to a particular part of speech, based on both its definition, as well as its context—i.e. relationship with adjacent and related words in a phrase, sentence, or paragraph, including an identification of multi-category words. A keywords determining module 32 is configured to determine a set of keywords, according to processing result.

The keywords determining module 32 is particularly configured to: indentify entity words from the processing result of the word segmenting module 31, abstract core words based on the identified core words, expand the core words to obtain expansion words, and output the core words and the expansion words as the set of keywords.

More particularly, the keywords determining module 32 needs to perform following steps.

1) Entity words identification: indentifying entity words from the processing result of the word segmenting module 31, based on a entity words list and a CRF model.

2) Core words obtaining: obtaining alternative words (including unary words, binary words, ternary words and entity words) from the processing result of the word segmenting module 31, calculating weights of the words, filtering phrases weighting below a specified threshold, and obtaining the core words; wherein regarding calculating weights of the words, in a particular embodiment, TF-IDF weights may be used (wherein, TF is current frequency of occurrence of an alternative word, and IDF is obtained by taking a logarithm of a quotient obtained by the total number of files in a statistics corpus divided by the number of files containing the alternative word); the weights of the words may also be obtained by other methods, for example, topic model method and so forth.

3) Core words expansion: determining synonyms and related words of the core words, considering the synonyms and related words as expansion words, calculating weights of the expansion words, and ranking the expansion words based on the weights, filtering expansion words weighting below the threshold, and taking the core words and expansion words as the desired set of keywords.

The question type analyzing module 33 is configured to determine the question type, according to the set of keywords determined by the keywords determining module 32.

Particularly, the technical solution provided by an embodiment of the application classifies questions based on their doubt phrases. Table 1 shows an example of a question type classification table about specific question types. The question type classification table as exampled by Table 1 is pre-stored. The question type analyzing module 33 inquires doubt phrases matching the set of keywords in the question type classification table, and outputs question type corresponding to the matching doubt phrases as the question type.

TABLE 1

| Question types | Examples of doubt phrases | Examples of questions |
|---|---|---|
| asking about | who/which one/what person | Who are you? |
| person | | |
| asking about time | what time/when/which year | When may I see you? |
| asking about sites | where/in which/what place | Where do you live? |
| and locations | | |
| asking about | why/what's the matter | Why is the sky blue |
| reasons | | |
| asking about | how much/how old/how high/ | How old are you? |
| quantities | how many | |
| asking about | what/what is | What is love? |
| definitions | | |

A user intent analyzing module 34 is configured to determine the user intention type, according to the set of keywords and a stored user model.

Particularly, the user model includes user information, such as, a user profile, a user type and user conversation histories. The user model may be collected and established in advance. Wherein, the user profile generally includes identification (e.g., ID), gender, age, occupation, and hobbies etc. of the user; the user type generally may be divided into younger users, intellectual users, literary users and rational users, according to the users' ages, occupations and hobbies; and the conversation history information is conversation histories reserved in related communication systems by the user, which include context information recently input by the user.

The user intention type may be, for example, a personal information class, a greeting class, a vulgarity class, a filtration class and a knowledge class. Table 2 shows a specific example of a user intention type classification table. The user intention type classification table as exampled by Table 2 is pre-stored. Recognition of the user intention type is completed by analyzing and matching according to user intention type classification table and inquiring the user intention type in the user intention type classification table, in connection with the set of keywords determined by the keywords determining module and the context information in the user model. And the user model may be further adjusted.

TABLE 2

| | Examples of context information input |
|---|---|
| User intention types | by a user and a set of keywords |
| personal information | What is your name; are you male or female; |
| class | where is your home; what is your contact |
| | information? |
| greeting class | Hi; nice to meet you; hello; good morning; |
| | how are you? |
| filtration class | narcotics |
| knowledge class | What is the weather today; why is the sky blue; |
| | how to get to Tsinghua university; |
| | what are good restaurants nearby? |

FIG. 3 is a schematic diagram of the syntax retrieving and ranking module 40 described by the application. The syntax retrieving and ranking module 40 is configured to find all answer candidates by retrieving the question and answer library and the classification tree, rank the answer candidates according to the retrieval relevance and the user model, and return an answer most suitable for the current question input by the user. As shown in FIG. 3, the syntax retrieving and ranking module 40 particularly includes following modules.

A question and answer library retrieving module 41 is configured to retrieve, in the question and answer library, answer candidates matching the set of keywords and calculate a question and answer library retrieval relevance between each of the answer candidates and the question information; wherein the question and answer library retrieval relevance indicates a degree of relevance between each of the answer candidates retrieved from the question and answer library and the question information; A category tree retrieving module 42 is configured to retrieve, in the category tree, answer candidates matching the question information, the set of keywords and the user intention type, according to preset template settings and model settings, and calculate a category tree retrieval a relevance between each of the answer candidates and the question information; wherein the category tree retrieval relevance indicates a degree of relevance between each of the answer candidates retrieved from the category tree and the question information; and An answers ranking module 43 is configured to calculate a total relevance between each of the answer candidates and the question information based on the question and answer library retrieval relevance and the category tree retrieval relevance, and rank the answer candidates according to the total relevance.

In the question and answer library retrieving module 41, a keyword index may be established for each of the questions in the question and answer library, and the answer candidates may be obtained by retrieving all question and answer pairs matching the abstracted set of keywords. During establishing the question and answer library, a answer form (such as, voices, texts and pictures, etc.), an answer candidate type and a question type corresponding to each of the answer candidates should be set. The answer candidate type corresponds to the user type in the user model; and the question type corresponds to the question type analyzed by the question type analyzing module, and may also be divided into “asking about person”, “asking about time”, and “asking about sites and locations” etc. as shown in FIG. 1.

The retrieval relevance between each of the answer candidates and the question information may be denoted by sim(x), which is similarity between a question paired with each of the answer candidates and the question proposed by the user. In an embodiment, sim(x) may be calculated by edit distance, i.e., literal similarity. Of course, sim(x) may be obtained by other approaches, such as, Euclidean distance, topic syntax distance and so on. An expression form of questions in the question and answer library is defined as text form, but answers forms may be various forms, including texts, voices, pictures, audios, videos and the like. Additionally, the answers may apply a universal label form, so that answers meet requirements of different roles may be flexibly set out. Table 3 shows an example of question and answer pairs in a question and answer library. Wherein \name and \function in the answer text represent name and function of the current role; and due to space constraints, the answer types and question types are not listed in Table 3. The question and answer library may be acquired by many ways, as long as question and answer pairs of questions proposed by users and answers to the questions may be obtained, which are generally obtained by human edit or semi-automatic study.

TABLE 3

| Question texts | Answer forms | Answer texts |
|---|---|---|
| Are you male or | voice; all users | \name is \sex |
| female? | | |
| What can you do? | text; all users | \name can do many things: |
| | | \function |
| Please send me a photo | picture; all users | \pic address |
| of you. | | |
| Would you marry me? | text; all users | Sorry, \name would never |
| | | get married. |
| May I have your contact | text; all users | You may send an email to |
| information? | | \email, or call \phone. |

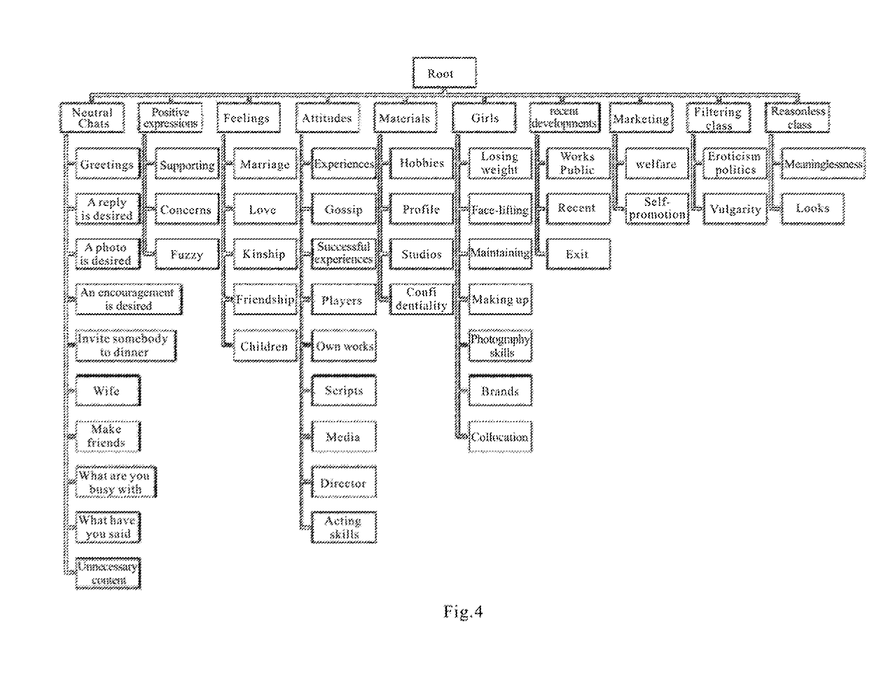

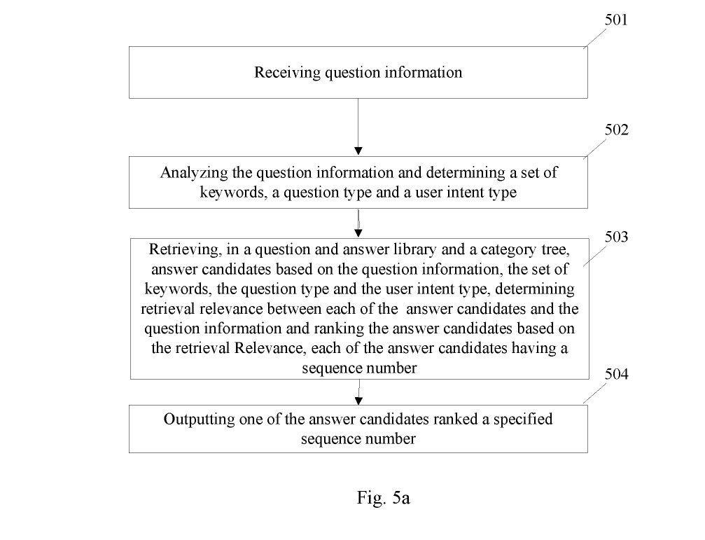

The category tree is storage form for storing tree structure setting information established by the application. The chatting robot of the application may play different roles, each of which may corresponds to a category tree. FIG. 4 shows a schematic diagram of a category tree corresponding to a chatting robot in a public role. Referring to FIG. 4, the category tree is in a tree structure, each of whose nodes corresponds to a model setting which is a classification model of the node. Each of the nodes represents a user intention type. The model setting corresponding to each of the nodes includes answer texts corresponding to the user intention type, and an answer form, an answer type and a corresponding question type of each of the answers. The answer may be in various forms, including voices, texts, pictures, audios, videos and so forth. The answer type corresponds to the user type in the user model. The question type corresponds to the question type analyzed by the question type analyzing module, and may also be divided into “asking about person”, “asking about time”, and “asking about sites and locations” etc. as shown in FIG. 1.

Each of the nodes in the classification tree may include multiple segmented template settings. Each of the template settings represents more detailed matching information about a question and answer pair, which includes specific question information, specific answer texts corresponding to the set of keywords, and the answer form and answer type of each on the answers. Table 4 shows an example of configuration information of a specific node on a category tree. Due to space constraints, the answer types and corresponding question types are not listed in Table 4.

TABLE 4

| Nodes | Template settings | Answer forms | Answer types |
|---|---|---|---|
| greeting | (hi\|hello\|nice to | voice; younger | Hello, \name is coming. |
| class | meet you\|good | users | |
| | morning) | voice; all users | Good (morning\|noon\|night). |
| | | voice; all users | Hi, I am \name. |
| marriage | [marriage] + (time\| | voice; younger | Leave feelings to fate. |
| class | when\|plan\|intend\|arrange); | users | Life can be wonderful without |
| | (partner\|couple\|boy | voice; rational | a man! |
| | friend) | users | |
| | (who\|requirenment) | text; all users | \name would never get married. |
| support | (like\|adore\| . . .) + [you]; | voice; younger | Ah, \name feels so shy. |
| class | [you] + (great\|my | users | |
| | idol\|very good\| . . .) | voice; all users | Thank you all like me! |
| | | voice; rational | Thanks, \name will keep |
| | | users | trying! |

As described in an embodiment, a method for the category tree retrieving module 42 retrieving the answer candidates matching the question information, the set of keywords and the user intention type from the category tree include the following steps.

Step 1): The template setting of each of the nodes on the category tree is retrieved with the question information and the set of keywords. It is determined whether one or more template settings match the question information; if any, answer text corresponding to the template setting is selected as an answer candidate and a category tree retrieval relevance match(x) for each of the answer candidates is calculated; otherwise, next step is performed.

For example, when a user questions “when will you get married”, a specific template setting of the marriage node is hit, i.e., “[marriage]+(time|when|plan|intend|arrange)”, and then answer text corresponding to the template setting is selected as an answer candidate.

In Step 1), for each of the template settings, a category tree retrieval relevance match(x) is calculated by a cover degree of the template, i.e., a length hit by the template divided by a length of the whole question. For example, when a user questions “when will you get married”, “marriage” and “when” in the template “[marriage]+(time|when|plan|intend|arrange)” is hit, and thus match(x)=4/6=0.67.

Step 2): The template setting of each of the nodes on the category tree is retrieved utilizing the user intention type. Since user intention types of template settings of all nodes on the category tree may cover candidate user intention types in the user intent analyzing module 34, a user intention type output by the user intent analyzing module 34 would match certain node on the category tree. Answer text corresponding to the node would then be selected as an answer candidate. A category tree retrieval relevance match(x) for each of the answer candidates is calculated

For example, when a user questions “where is your hometown”, the user intention type is analyzed by the user intent analyzing module as “profile class”, so that a profile node on the category tree as shown by FIG. 4 is matched.

In Step 2), for each of the template settings, the category tree retrieval relevance match(x) is calculated by strength of the user intent. For example, when a user questions “where is your hometown”, the user intention type is analyzed by the user intent analyzing module as “profile class” and the strength of the user intent is 0.8, so that match(x)=0.8. The strength of the user intent is obtained by classification question training prediction, details for which may refer to prior art and is thus not repeated herein.

The answers ranking module 43 is configured to calculate the total relevance between each of the answer candidates and the question information based on the question and answer library retrieval relevance and the category tree retrieval relevance, and rank the answer candidates according to the total relevance. And then the outputting module outputs an answer candidate ranked with a specified number, such as outputting the answer through a speaker.

Particularly, the answers ranking module 43 may rank the results of the question and answer retrieval and the category retrieval according to the user model, calculate a total relevance p(x) for each of the answer candidates (x), and return the optimal answer to the outputting module 50. The question and answer library sets an answer for each specific question, so the answers are accurate; while the category tree set answers for a class of questions, so the answers are obscure. The ranking module returns answer candidates of the question and answer library in priority, when answer candidates of the question and answer library and answer candidates of the category tree are of the same probability. Meanwhile, in order to improve sense of reality, the ranking module returns answers consistent with the user type and voice answers. Calculation of the relevance may be carried out using various calculation methods, which will be described in details below.

In an embodiment, the answers ranking module 43 is further configured to: determine whether an answer form of any one of the answer candidates is a specified form; and if an answer form of any one of the answer candidates is the specified form, increase the total relevance p(x) of the answer candidate.

In another embodiment, the answers ranking module 43 is further configured to: acquire, in stored user models, user type information of the user proposing the question, determine whether an answer type of each of the answer candidates is consistent with the user type; and if an answer type of any one of the answer candidates is consistent with the user type, increase the total relevance p(x) of the answer candidate.

In another embodiment, the answers ranking module 43 is further configured to: determine whether a question type of each of the answer candidates is consistent with the question type determined by the question analyzing module 30; and if a question type of any one of the answer candidates is consistent with the question type determined by the question analyzing module 30, increase the total relevance p(x) of the answer candidate.

A simple method used by the answers ranking module to calculate p(x) is set out herein, which is shown by Equation 1.

p(x)=α.sim(x)+β.match(x)+θ.voice(x)+δ.user(x)+σ.type(x) (Equation 1)

Wherein, p(x) denotes the total relevance of current answer candidate; sim(x) denotes the question and answer library retrieval relevance between the answer candidate and the question information, and regarding retrieval results from the category tree, sim(x) is 0; match(x) denotes the category tree retrieval relevance between the answer candidate and the question information, and regarding retrieval results from the question and answer library, match(x) is 0; voice(x) indicates whether an answer form of the answer candidate is voice form, and if the answer form is voice form, voice(x) is 1, and otherwise voice(x) is 0; user(x) indicates whether an answer type of the answer candidate is consistent with a user type in user models, and if the answer type is consistent with the user type in user models, user(x) is 1, and otherwise user(x) is 0; type(x) indicates whether the answer type of the answer candidate meets the analyzed question type, and if the answer type meets the analyzed question type, type(x) is 1, and otherwise type(x) is 0; and wherein parameters meets 1>α>β>δ>θ>σ>0.

As scale of nodes of the category tree is not too large (generally, smaller than 1 k), answers may be customized for each user on the nodes of the category tree, so that, different answers may be provided to users based on types of the users, as shown in FIG. 4.

A large amount of offline mining is required to create category trees. The category trees for robots playing different roles generally differ from each other. But offline mining processes are generally the same, which are achieved on basis of a lot of questions related to each role and by clustering by text similarity and theme of the questions. As shown in FIG. 4, the category tree of public role covers comprehensively, i.e., most conversations between users and the role may be matched by nodes on the category tree, so that a small amount of general answers may achieve conversations with certain reality. Therefore, different kinds of roles may be covered utilizing little operation and collection costs, while the question and answer library does not have to fully cover all questions may be proposed by the users. Therefore, a relative high successful rate of answers may be reached by combining the question and answer library with category trees. As a result, operation and collection costs of the question and answer library are decreased and storage resources occupied by the question and answer library are saved.

As costs for creating the question and answer library and category trees are much littler than existing chatting system, the system for automatic question answering may be more universal. As long as each of different roles sets a question and answer library and category tree related to itself, it may chat with users. For example, a recruitment role, may implement automatic conversations related to recruitment, by entering question and answer pairs related to recruitment into a question and answer library and entering recruitment rules (such as, recruitment time and interview results, etc.) into a category tree; a game role, may implement automatic conversations related to game, by entering question and answer pairs related to game into a question and answer library and entering game rules (such as, activation codes and props, etc.) into a category tree. That is to say, each of various roles only has to configure its question and answer library and category tree.

Additionally, conversations between the existing chatting systems and users lack personality. For each of the users, answers to one question are always the same or randomly selected from several answers, regardless of context of the users and their individual factors. Embodiments of the application take full advantage of contexts in the user models and the users' individual factors, so that answers to the same questions proposed by different users may be different. Therefore, conversations between users and the chatting robots are more real and flexible.

Additionally, in various embodiments of the application, various function modules may be integrated in one processing unit or separately exist, or two or more modules may be integrated in one unit. The above-mentioned integrated units may be implemented as hardware or software function units. In various embodiments of the application, various function modules may located in one terminal or network node, or be separated into several terminals or network nodes.

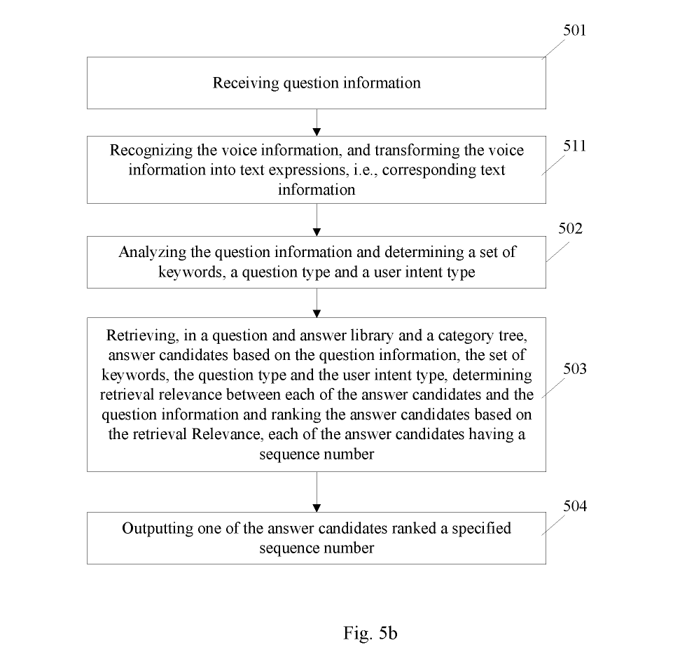

Corresponding to the above system for automatic question answering, the application discloses a method for automatic question answering, which may be performed by the system for automatic question answering. FIG. 5a is a flow diagram of an embodiment of the method for automatic question answering described by the application. Referring to FIG. 5a, the method includes following steps.

Step 501: receiving question information.

Step 502: analyzing the received question information to determine a set of keywords, a question type and a user intention type.

Step 503: retrieving, in a question and answer library and a category tree, answer candidates based on the question information, the keywords, question type and user intention type, determining the retrieval relevance between each of the answer candidates and the question information and ranking the answer candidates based on the retrieval relevance.

Step 504: outputting an answer candidate ranked with a specified number, for example, an answer candidate ranked first or top n (wherein n is a an integer).

In the embodiment as shown in FIG. 5a, the input question information may be text information. An embodiment of the application may provide an interface (such as, a chat window) to the user for inputting the text information; and the questioning user may input the question information in text form by the chat window.

FIG. 5b is a flow diagram of another embodiment of the method for automatic question answering described by the application. Referring to FIG. 5b, this embodiment may be applied to a scene where a user inputs question information by voice. This embodiment differs from the embodiment shown by FIG. 5a in that the embodiment may provide a module (such as, a audio inputting module) for voice input, which may be connected to an external microphone to receive voice information input by a user; and in the embodiment, the method further includes Step 511 after Step 501, In step 511, when voice information input by a user is received, the voice information may be recognized and transformed into text expressions, i.e., corresponding text information, and then the corresponding text information may be output to subsequent Step 502. Accordingly, question answering conversations between a user and the system for automatic question answering may be implemented in voice, so as to bring a sense of reality and freshness to the user. In Step 501, when text information input by a user is received, the text information may be directly transmitted to subsequent Step 502. Approaches for recognizing voice information into text information may refer to prior voice recognition technology, and is thus not repeated herein

In an embodiment, Step 502 particularly includes following steps.

Step 521: processing the question information by word segmentation and/or part-of-speech tagging.

Step 522: determining a set of keywords, according to processing result of the word segmentation and/or part-of-speech tagging, which particularly includes: indentifying entity words from the processing result of the word segmentation and/or part-of-speech tagging, obtaining core words based on the identified entity words, expanding the core words to obtain expansion words, and outputting the core words and the expansion words as the set of keywords.

Step 523: determining the question type, according to the set of keywords.

Step 524: determining the user intention type, according to set of keywords and a stored user model.

Particularly, Step 522 includes following steps.

Step 5221: entity words identification: indentifying entity words from the processing result of Step 521, based on an entity words list and a CRF model.

Step 5222: core words obtaining: obtaining alternative words (including unary words, binary words, ternary words and entity words) from the processing result of Step 521, calculating weights of the words, filtering phrases weighting below a specified threshold, and obtaining the core words; wherein regarding calculating weights of the words, in a particular embodiment, TF-IDF weights may be used (wherein, TF is current frequency of occurrence of an alternative word, and IDF is obtained by taking a logarithm of a quotient obtained by the total number of files in a statistics corpus divided by the number of files containing the alternative word); the weights of the words may also be obtained by other methods, for example, topic model method and so forth.

Step 5223: core words expansion: determining synonyms and related words of the core words, considering the synonyms and related words as expansion words, calculating weights of the expansion words, and ranking the expansion words based on the weights, filtering expansion words weighting below the threshold, and considering the core words and expansion words as the desired set of keywords.

In an embodiment, Step 503 particularly includes following steps.

Step 531: retrieving, in the question and answer library, answer candidates matching the set of keywords and calculating the question and answer library retrieval relevance between each of the answer candidates and the question information.

Step 532: retrieving, in the category tree, answer candidates matching the question information, the set of keywords and the user intention type, according to preset template settings and model settings, and calculating the category tree retrieval relevance between each of the answer candidates and the question information.

Step 533: calculating the total relevance between each of the answer candidates and the question information based on the question and answer library retrieval relevance and the category tree retrieval relevance, and ranking the answer candidates according to the total relevance.

Step 532 further includes following steps.

Step 5321: The template setting of each of the nodes on the category tree is retrieved with the question information and the set of keywords. It is determined whether one or more template settings match the question information; if any, answer text corresponding to the template setting is selected as an answer candidate and category tree retrieval relevance match(x) for each of the answer candidates is calculated; otherwise, next Step 5322 is performed.

For example, when a user questions “when will you get married”, a specific template setting of the marriage node is hit, i.e., “[marriage]+(time|when|plan|intend|arrange)”, and then answer text corresponding to the template setting is selected as an answer candidate.

In Step 5321, for each of the template settings, a category tree retrieval relevance match(x) is calculated by a cover degree of the template, i.e., a length hit by the template divided by a length of the whole question. For example, when a user questions “when will you get married”, “marriage” and “when” in the template “[marriage]+(time|when|plan|intend|arrange)” is hit, and thus match(x)=4/6=0.67.

Step 5322: The template setting of each of the nodes on the category tree is retrieved with the user intention type. Since user intention types of template settings of all nodes on the category tree may cover candidate user intention types in the user intent analyzing module 34, a user intention type output by the user intent analyzing module 34 would match certain node on the category tree. Answer text corresponding to the node would then be selected as an answer candidate. The category tree retrieval relevance match(x) for each of the answer candidates is calculated.

For example, when a user questions “where is your hometown”, the user intention type is analyzed by the user intent analyzing module as “profile class”, so that a profile node on the category tree as shown by FIG. 4 is matched.

In Step 5322, for each of the template settings, the category tree retrieval relevance match(x) is calculated by strength of the user intent. For example, when a user questions “where is your hometown”, the user intention type is analyzed by the user intent analyzing module as “profile class” and the strength of the user intent is 0.8, so that match(x)=0.8. The strength of the user intent is obtained by classification question training prediction, details for which may refer to prior art and is thus not repeated herein.

Particularly, in Step 533, the results of the question and answer retrieval and the category retrieval may be ranked according to the user model; the total relevance p(x) for each of the answer candidates (x) may be calculate; and the optimal answer may be returned and output to the user. The question and answer library sets an answer for each specific question, so the answers are accurate; while the category tree set answers for a class of questions, so the answers are obscure. The ranking module returns answer candidates of the question and answer library in priority, when answer candidates of the question and answer library and answer candidates of the category tree are of the same probability. Meanwhile, in order to improve sense of reality, the ranking module returns answers consistent with the user type and voice answers. Calculation of the relevance may be carried out using various calculation methods, which will be described in details below.

In an embodiment, Step 533 further includes: determining whether an answer form of any one of the answer candidates is a specified form; and if an answer form of any one of the answer candidates is the specified form, increasing the total relevance p(x) of the answer candidate.

In another embodiment, Step 533 further includes: acquiring, in stored user models, user type information of the user proposing the question, determine whether an answer type of each of the answer candidates is consistent with the user type; and if an answer type of any one of the answer candidates is consistent with the user type, increasing the total relevance p(x) of the answer candidate.

In another embodiment, Step 533 further includes: determining whether a question type of each of the answer candidates is consistent with the question type determined by Step 502; and if a question type of any one of the answer candidates is consistent with the question type determined by Step 502, increasing the total relevance of the answer candidate.

A simple method for calculating p(x) is set out herein, which is shown by Equation 1.

p(x)=α.sim(x)+β.match(x)+θ.voice(x)+δ.user(x)+σ.type(x) (Equation 1)

Wherein, p(x) denotes the total relevance of current answer candidate; sim(x) denotes question and answer library retrieval the between the answer candidate and the question information, and regarding retrieval results from the category tree, sim(x) is 0; match(x) denotes category tree retrieval the between the answer candidate and the question information, and regarding retrieval results from the question and answer library, match(x) is 0; voice(x) indicates whether an answer form of the answer candidate is voice form, and if the answer form is voice form, voice(x) is 1, and otherwise voice(x) is 0; user(x) indicates whether an answer type of the answer candidate is consistent with a user type in user models, and if the answer type is consistent with the user type in user models, user(x) is 1, and otherwise user(x) is 0; type(x) indicates whether the answer type of the answer candidate meets the analyzed question type, and if the answer type meets the analyzed question type, type(x) is 1, and otherwise type(x) is 0; and wherein parameters meets 1>α>β>δ>θ>σ>0.

In conclusion, utilizing the application, a user may input voice information or text information; the system for automatic question answering retrieves the question and answer library and the syntax category tree by keywords obtaining and intent recognizing, to find matching question and answer pairs and syntax nodes, calculates relevance between each of the answer candidates and the question information, and returns the optimal answer to the user. The method for automatic question answering according to the application may support not only traditional conversations based on question and answer libraries and matching rules, but also voice conversations, conversations in several roles, and conversations with a few category answers to reach certain reality. This application may be applied to various customer service robot systems, systems for automatic conversations with virtual characters and systems for automatic conversations with public characters, etc.

For example, Table 5 shows examples of conversations with a voice chatting robot, which is currently a virtual character named V, wherein the user is a younger user.

TABLE 5

| User inputs | Answers from the system |
|---|---|
| Voice: Hi. | Voice: Hello, V is coming. |
| Voice: Are you a boy or a girl? | Text: V is female. |
| Voice: I like you so much. | Voice: Ah, V feels so shy. |
| Voice: Really? | Voice: Of course. |
| Voice: What kind of boyfriend | Voice: Leave feelings to fate. |
| do you like? | |
| Voice: Can you get married? | Text: Sorry, V would never get married. |

Additionally, all embodiments provided by the application may be implemented by data processing programs executed by data processing devices, such as a computer. Further, the data processing programs stored on non-transient storage media may be performed by directly read from the storage media or installed on or copied to a storage device (such as, a hard disk or a memory) of the data processing device. Therefore, the application may also be implemented by storage media. The storage media may use any recording modes, for example, paper storage media (such as tape, etc.), magnetic storage media (such as, floppy disks, hard disks, flash memory, etc.), optical storage media (such as, CD-ROMs, etc.), magneto-optical storage media (such as, MO, etc.).

Therefore, the application also discloses a storage medium, wherein data processing programs are stored. The data processing programs are configured to perform any of the embodiments of the above method of the application.

The above embodiments only show several implementations of the application, and cannot be interpreted as limitations to the application. It should be noted that any modifications, alternations or improvements falling within the spirit and principle of the application should be covered by the protection scope of the application.

What is claimed is:

1. A system for automatic question answering, comprising:
a user inputting module configured to receive question information;
a question analyzing module configured to analyze the question information, and determine a set of keywords, a question type and a user intention type corresponding to the question information;
a syntax retrieving and ranking module configured to retrieve, in a question and answer library and a category tree, answer candidates based on the question information, the set of keywords, the question type and the user intention type, determine a retrieval relevance between each of the answer candidates and the question information, and rank the answer candidates according to the retrieval relevance, each of the answer candidates having a sequence number; and
an outputting module configured to output one of the answer candidates ranked with a specified sequence number.

2. The system according to claim 1, wherein the question analyzing module comprises:
a word segmenting module configured to process the question information by word segmentation or part-of-speech tagging, and obtain a processing result;
a keywords determining module configured to determine a set of keywords, according to the processing result;
a question type analyzing module configured to determine the question type, according to the set of keywords; and
a user intention analyzing module configured to determine the user intention type, according to the set of keywords and a stored user model.

3. The system according to claim 2, wherein the keywords determining module is further configured to indentify entity words from the processing result of the word segmenting module, obtain core words from the entity words, expand the core words to obtain expansion words, and output the core words and the expansion words as the set of keywords.

4. The system according to claim 1, wherein the syntax retrieving and ranking module comprises:
a question and answer library retrieving module configured to retrieve, in the question and answer library, answer candidates matching the set of keywords and calculate a question and answer library retrieval relevance between each of the answer candidates and the question information;
a category tree retrieving module configured to retrieve, in the category tree, answer candidates matching the question information, the set of keywords and the user intention type, according to preset template settings and model settings, and calculate the category tree retrieval relevance between each of the answer candidates and the question information; and
an answers ranking module, configured to calculate a total relevance between each of the answer candidates and the question information based on the question and answer library retrieval relevance and the category tree retrieval relevance, and rank the answer candidates according to the total relevance.

5. The system according to claim 4, wherein the answers ranking module is further configured to:
determine whether an answer form of one of the answer candidates is a specified form; and if the answer form of one of the answer candidates is the specified form, increase the total relevance of the answer candidate.

6. The system according to claim 4, wherein the answers ranking module is further configured to:
acquire, in stored user models, user type information of the user proposing the question information, wherein the user type information indicating a user type of the user, determine whether an answer type of one of the answer candidates is consistent with the user type; and if the answer type of one of the answer candidates is consistent with the user type, increase the total relevance of the answer candidate.

7. The system according to claim 4, wherein the answers ranking module is further configured to:
determine whether question type of one of the answer candidates is consistent with the question type determined by the question analyzing module; and if the question type of one of the answer candidates is consistent with the question type determined by the question analyzing module, increase the total relevance of the answer candidate.

8. The system according to any one of claims 1, wherein the system further comprises a voice recognizing module, which is configured to, when the question information is voice information, recognize the voice information and output the recognized result to the question analyzing module.

9. A method for automatic question answering, comprising:
receiving question information;
analyzing the question information, and determining a set of keywords, a question type and a user intention type corresponding to the question information;
retrieving, in a question and answer library and a category tree, answer candidates based on the question information, the set of keywords, the question type and the user intention type;
determining a retrieval relevance between each of the answer candidates and the question information;
ranking the answer candidates according to the retrieval relevance, each of the answer candidates having a sequence number; and
outputting one of the answer candidate ranked with a specified sequence number.

10. The method according to claim 9, wherein the analyzing step further comprises following steps:
processing the question information by word segmentation or part-of-speech tagging, and obtaining a processing result;
determining a set of keywords according to the processing result;
determining the question type according to the set of keywords; and
determining the user intention type according to the set of keywords and a stored user model.

11. The method according to claim 10, wherein the step of determining the set of keywords further comprises following steps:
indentifying entity words from the processing result of the word segmentation and/or part-of-speech tagging;
obtaining core words from the entity words;
expanding the core words to obtain expansion words; and
outputting the core words and the expansion words as the set of keywords.

12. The method according to claim 9, wherein the retrieving step comprise following steps:
retrieving, in the question and answer library, answer candidates matching the set of keywords and calculating a question and answer library retrieval relevance between each of the answer candidates and the question information;
retrieving, in the category tree, answer candidates matching the question information, the set of keywords and the user intention type according to template settings and model settings, and calculating a category tree retrieval relevance between each of the answer candidates and the question information; and
calculating a total relevance between each of the answer candidates and the question information based on the question and answer library retrieval relevance and the category tree retrieval relevance, and ranking the answer candidates according to the total relevance.

13. The method according to claim 12, wherein the method further comprises the following steps:
determining whether an answer form of one of the answer candidates is a specified form; and
if the answer form of one of the answer candidates is the specified form, increasing the total relevance of the answer candidate.

14. The method according to claim 12, wherein the method further comprises the following steps:
acquiring, in stored user models, user type information of the user proposing the question information, wherein the user type information indicating a user type of the user;
determining whether an answer type of one of the answer candidates is consistent with the user type; and
if the answer type of one of the answer candidates is consistent with the user type, increasing the total relevance of the answer candidate.

15. The method according to claim 12, wherein the method further comprises the following steps:
determining whether question type of one of the answer candidates is consistent with the question type determined by the analyzing step; and
if the question type of one of the answer candidates is consistent with the question type determined by the analyzing step, increasing the total relevance of the answer candidate.

16. The method according to claim 12, wherein the step of calculating the total relevance of the answer candidates comprises:
calculating the total relevance of the answer candidates according to Equation 1:
p(x)=α.sim(x)+β.match(x)+θ.voice(x)+δ.user(x)+σ.type(x),
wherein, p(x) denotes the total relevance of current answer candidate; sim(x) denotes the question and answer library retrieval relevance of the answer candidate to the question information, and regarding retrieval results from the category tree, sim(x) is 0; match(x) denotes the category tree retrieval relevance of the answer candidate to the question information, and regarding retrieval results from the question and answer library, match(x) is 0; voice(x) indicates whether an answer form of the answer candidate is voice form, and if the answer form is voice form, voice(x) is 1, and otherwise voice(x) is 0; user(x) indicates whether an answer type of the answer candidate is consistent with a user type in user models, and if the answer type is consistent with the user type in user models, user(x) is 1, and otherwise user(x) is 0; type(x) indicates whether the answer type of the answer candidate meets the analyzed question type, and if the answer type meets the analyzed question type, type(x) is 1, and otherwise type(x) is 0; and wherein parameters meet 1>α>β>δ>θ>σ>0.

17. The method according to any one of claims 9, wherein before analyzing the question information, the method further comprises:
when the question information is voice information, recognizing the voice information and generating text information, and analyzing the text information to determine the set of keywords, the question type and the user intention type.
